(19) United States
(12) Patent Application Publication
(10) Pub. No.: US 2006/0136668 A1
(43) Pub. Date: Jun. 22, 2006

(54) Allocating code objects between faster and slower memories

(76) Inventor: John C. Rudelic, Folsom, CA (US)

Correspondence Address: TROP PRUNER & HU, PC, 8554 KATY FREEWAY, SUITE 100, HOUSTON, TX, 77024, US

(21) Appl. No.: 11/015,554

(22) Filed: Dec. 17, 2004

(51) Int. Cl. G06F 13/00

(52) U.S. Cl. 711/118

(57) ABSTRACT

Code objects stored in faster and slower memory may be checked to determine their access frequency. For example, in connection with a paging system, a reference count may be accessible. Based on the reference count and other statistics, code objects that are more frequently accessed may be moved to faster memories, such as faster flash memories, and code objects that are less frequently accessed may be moved to slower memories. In some embodiments, this will increase the access speed of the data in the system as a whole.

### BACKGROUND

This invention relates generally to processor-based systems and, particularly, to storage systems for those processor-based systems.

Many processor-based systems include multiple memories that store different code objects. For example, as delivered, some computer systems store the operating system, the memory management interface (MMI), and various libraries, as well as original equipment manufacturer and carrier applications in faster flash memory. This leaves the slower flash memory for user storage purposes.

However, some of the original equipment and carrier applications and some libraries may be infrequently accessed. Thus, the system performance may be adversely degraded because user applications, which are frequently accessed, are accessed slowly because they are stored in flash memories with slower access times.

Thus, there is a need to better manage memories in processor-based systems.

### BRIEF DESCRIPTION OF THE DRAWINGS

FIG. 1 is a system depiction in accordance with one embodiment of the present invention;

FIG. 2 is a software depiction in accordance with one embodiment of the present invention;

FIGS. 3A and 3B show the file systems in a faster and a slower flash memory as originally configured in accordance with one embodiment of the present invention and as subsequently configured; and

FIG. 4 is a flow chart for software for one embodiment of the present invention.

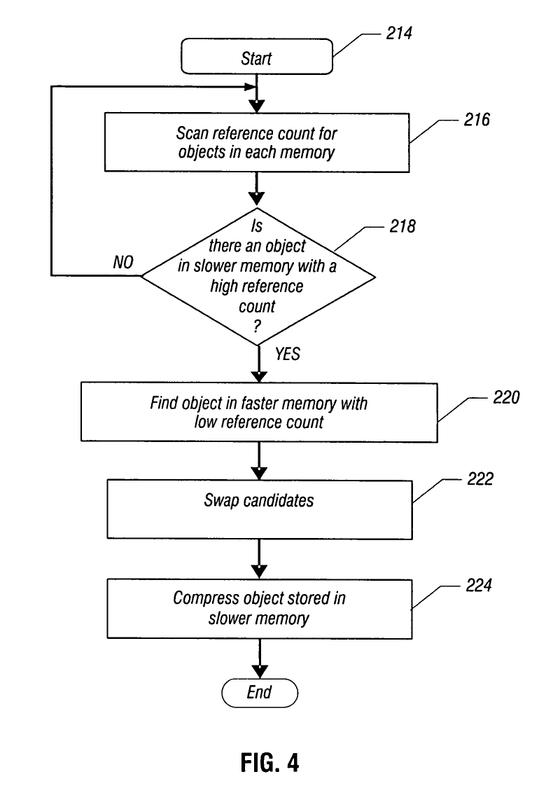

### DETAILED DESCRIPTION

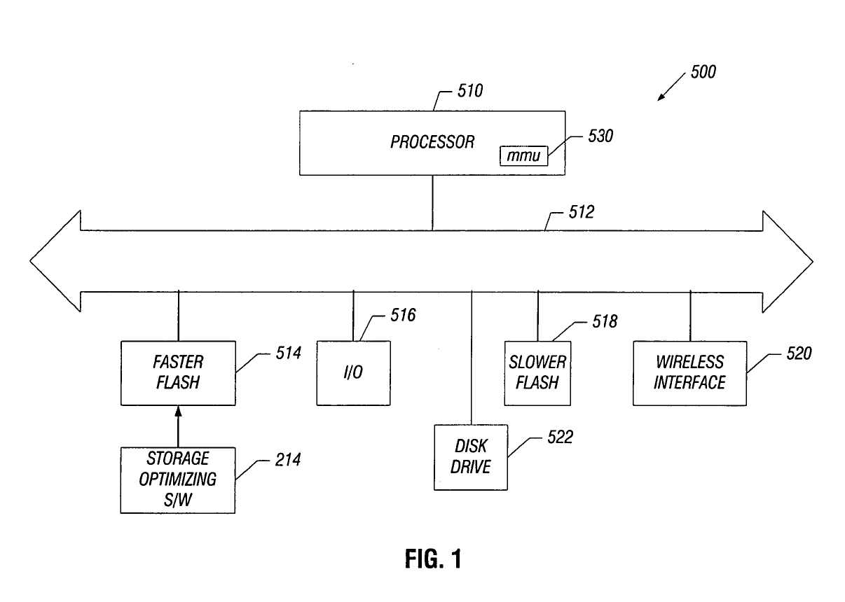

Referring to FIG. 1, a processor-based system 500 may be a mobile processor-based system in one embodiment. For example, the system 500 may be a handset or cellular telephone. In one embodiment, the system 500 includes a processor 510 with an integral memory management unit (MMU) 530. In other embodiments, the memory management unit 530 may be a separate chip.

The processor 510 may be coupled by a bus 512 to a faster flash memory 514 and a slower flash memory 518. The memories 514 and 518 may be the same or different types of memory and may be memories other than flash memory.

In some embodiments, an input/output (I/O) device 516 may also be coupled to the bus 512. Examples of input/output devices include keyboards, mice, displays, serial buses, parallel buses, and the like.

A wireless interface 520 may also be coupled to the bus 512. The wireless interface 520 may enable any radio frequency protocol in one embodiment of the present invention, including a cellular telephone protocol. The wireless interface 520 may, for example, include a cellular transceiver and an antenna, such as a dipole, or other antenna.

The memories 514 and 518 may be used, for example, to store messages transmitted to or by the system 500. The memory 514 or 518 may also be optionally used to store instructions that are executed by the processor 510 during operation of the system 500, as well as user data. While an example of a wireless application is provided, embodiments of the present invention may also be used in non-wireless and non-mobile applications as well.

The memory management unit 530 is a hardware device or circuit that supports virtual memory and paging by translating virtual addresses into physical addresses. The virtual address space is divided into spaces whose size is 2^{N}. The bottom N bits of the address are left unchanged. The upper address bits are the virtual page number.

The memory management unit 530 may contain a page table that is indexed by the page number. Each page table entry gives a physical page number corresponding to a virtual one. This is combined with the page offset to give the complete physical address. The page table entry may also include information about whether the page has been written to, when it was last used, what kind of processes may read and write it, and whether it should be cached.

After blocks of memories have been allocated and freed, the free memory may become fragmented so that the largest contiguous block of free memory may be much smaller than the total amount of memory. With virtual memory, a contiguous range of virtual addresses can be mapped to several non-contiguous blocks of physical memory.

Also coupled to the bus 512 may be a disk drive or other mass storage device. A storage optimizing software 214 may be stored, for example, on the faster flash memory 514.

With some embodiments of the present invention, code objects that are used more frequently are gravitated to the faster flash memory 514. Those code objects that are used less frequently are gravitated to the slower flash memory 518. Some of the code objects in the flash memory 518 that are less frequently utilized may be compressed so that the storage capability of the system is increased. Because more commonly utilized elements are more quickly accessible in the faster flash memory 514, the performance of the system may be increased in some embodiments of the present invention.

While the storage optimizing software 214 is shown as being stored on the faster flash memory 514, it may also be stored on the slower flash memory 518 or in association with other memory in the processor-based system 500 including a dynamic random access memory (not shown).

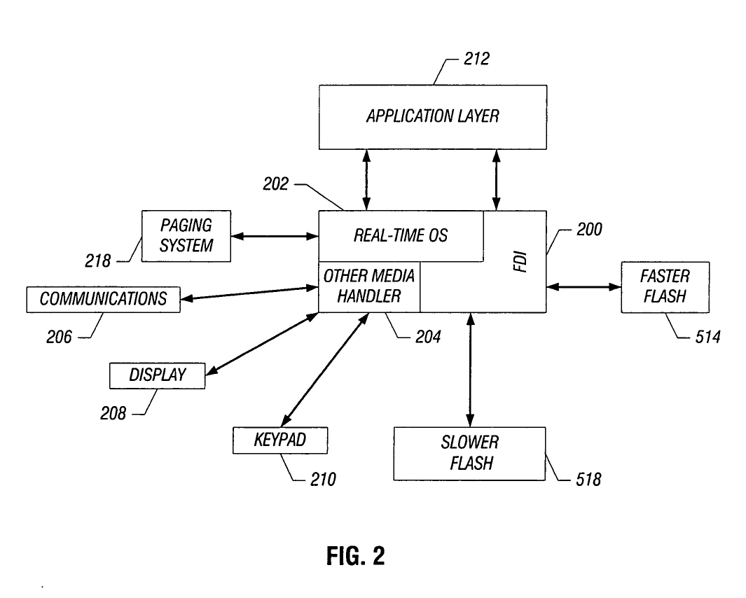

Referring to FIG. 2, an application level depiction of the system 500, in one embodiment, includes an application layer 212, coupled to a real time operating system 202. The real time operating system 202 may be coupled to a flash data integrator, such as the Intel FDI Version 5, available from Intel Corporation, Santa Clara, Calif. The flash data integrator 200 is a code and data storage manager for use in real time embedded applications. It may support numerically identified data parameters, data streams for voice recordings and multimedia, Java applets, and native code for direct execution.

The FDI 200 background manager handles power loss recovery and wear leveling of flash data blocks to increase cycling endurance. It may incorporate hardware-based read-while-write. The code manager within the FDI 200 provides storage and direct execution-in-place of Java applets and native code. It may also include other media handlers 204 to handle keypads 210, displays 208, and communications 206. The real time operating system 218 may work with the paging system 218, implemented by the memory management unit 530.

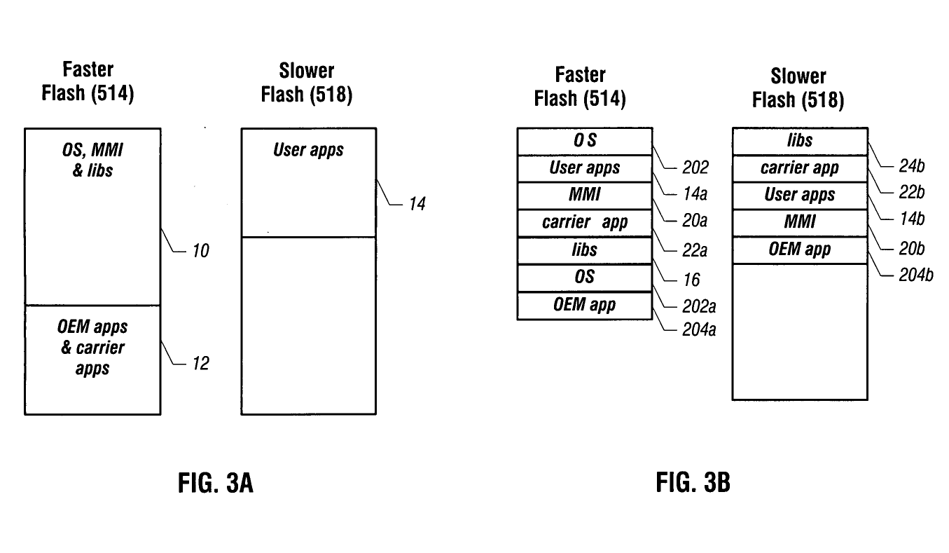

Referring to FIG. 3A, the file systems on the faster flash memory 514 and slower flash memory 518 may be originally provided by an original equipment manufacturer. In such case, the faster flash memory 514 may store the operating system, MMI and libraries, as indicated at 10, and original equipment manufacturer applications and carrier applications as indicated at 12. This leaves the slower flash memory 518 for the user applications 14.

In the course of operation of embodiments of the present invention, code objects that tend to be used more are gravitated to the faster flash 514 and those objects that are used less gravitate to the slower flash 518.

Thus, as an example, after some time of operation, as indicated in FIG. 3B, the faster flash memory 514 may include the operating system 202, the user applications 14a that are more frequently accessed, MMI code objects 20a, the carrier applications 22a, the libraries 16a, additional operating systems 202, and some other original equipment applications 204a.

At the same time, the slower flash memory 518 may store libraries 24b that are less frequently accessed, carrier applications 22b that are less frequently accessed, user applications 14b that are less frequently accessed, MMI code objects 20b that are less frequently accessed, and original equipment applications 204b that are less frequently accessed.

The software 214, in one embodiment, may begin by scanning reference counts for objects in each memory 514 and 518. The reference counts indicate how many times each code object has been accessed. As pages are referenced by the MMU 530, the reference count for each page is incremented. By scanning the reference counts for objects in each memory 514, 518, as indicated in block 216, a determination can be made as to whether certain objects in certain memories 514, 518 are accessed more frequently than others. Then, in diamond 218, a check determines whether there is an object in the slower memory 518 with a higher reference count than objects stored in the faster memory 514.

In block 220, the object in the faster memory 514 with the lower reference count is identified and is swapped with a more frequently accessed object in the slower memory 518 as indicated in block 222. The object being stored in the slower memory 518 may, in some embodiments, be compressed, as indicated in block 224, to increase the storage in the slower memory 518. Compressing the code pages, stored in slower memory 518, may be acceptable because those pages are accessed infrequently.

In accordance with some embodiments of the present invention, the paging system provides the mechanism for tabulating the relative memory access frequency. As objects are accessed, the object reference count is incremented. As the reference count for an object in the slower memory 518 increases, it becomes a candidate for migration to the faster memory 514. Likewise, as an object in the faster memory goes unreferenced, it becomes a candidate for migration to the slower memory 518. The system can apply statistical metrics to choose specific code objects to swap.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
determining how frequently code objects in a slower memory are accessed; and
based on that determination, moving a more frequently accessed code object to a faster memory for storage.

2. The method of claim 1 including accessing a reference count to determine how frequently a code object is accessed.

3. The method of claim 1 including using a paging system to determine how frequently a code object is accessed.

4. The method of claim 3 including using a memory management unit to determine how frequently a code object is accessed.

5. The method of claim 1 including determining how frequently code objects in faster and slower memories are accessed.

6. The method of claim 5 including moving less frequently accessed code objects to slower memory.

7. The method of claim 6 including swapping objects between slower and faster memory based on access frequency.

8. The method of claim 7 including using statistical metrics to decide whether to swap objects.

9. The method of claim 7 including swapping objects between flash memories.

10. The method of claim 1 including compressing objects stored on said slower memory.

11. An article comprising a medium storing instructions that, if executed, enable a processor-based system to:
determine how frequently code objects in a slower memory are accessed; and
based on that determination, move a more frequently accessed code object to a faster memory for storage.

12. The article of claim 11 further storing instructions that, if executed, enable a processor-based system to access a reference count to determine how frequently a code object is accessed.

13. The article of claim 11 further storing instructions that, if executed, enable a processor-based system to use a paging system to determine how frequently a code object is accessed.

14. The article of claim 13 further storing instructions that, if executed, enable a processor-based system to use a memory management unit to determine how frequently a code object is accessed.

15. The article of claim 11 further storing instructions that, if executed, enable a processor-based system to determine how frequently code objects in faster and slower memories are accessed.

16. The article of claim 15 further storing instructions that, if executed, enable a processor-based system to move less frequently accessed code objects to slower memory.

17. The article of claim 16 further storing instructions that, if executed, enable a processor-based system to swap objects between slower and faster memory based on access frequency.

18. The article of claim 17 further storing instructions that, if executed, enable a processor-based system to use statistical metrics to decide whether to swap objects.

19. The article of claim 17 further storing instructions that, if executed, enable a processor-based system to swap objects between flash memories.

20. The article of claim 11 further storing instructions that, if executed, enable a processor-based system to compress objects stored in the slower memory.

21. A system comprising:
a processor;
a memory management unit associated with said processor;
a slower memory coupled to said processor;
a faster memory coupled to said processor;
said processor to determine how frequently code objects in the slower memory are accessed and, based on that determination, move a more frequently accessed code object to a faster memory for storage; and
a wireless interface coupled to said processor.

22. The system of claim 21 wherein said slower and faster memory are both flash memories.

23. The system of claim 21 wherein said wireless interface is a dipole antenna.

24. The system of claim 21 wherein said processor to access a reference count to determine how frequently a code object is accessed.

25. The system of claim 21 including a paging system to determine how frequently a code object is accessed.

26. The system of claim 25 wherein said processor to use the memory management unit to determine how frequently a code object is accessed.

27. The system of claim 21, said processor to determine how frequently code objects in the faster and slower memories are accessed.

28. The system of claim 25, said processor to move less frequently accessed objects to the slower memory.

29. The system of claim 28, said processor to swap objects between the slower and faster memories based on access frequencies.

30. The system of claim 29, said processor to use statistical metrics to decide whether to swap objects.
